(19) United States
(12) Patent Application Publication
(10) Pub. No.: US 2018/0139144 A1
(43) Pub. Date: May 17, 2018

(54) METHODS AND SYSTEMS FOR EXCHANGING INFORMATION OVER A USER PLANE BETWEEN WLAN AND 3GPP RAN FOR TRAFFIC STEERING THRESHOLD DETERMINATION

(71) Applicant: Kyocera Corporation, Kyoto (JP)

(72) Inventor: David COMSTOCK, San Diego, CA (US)

(21) Appl. No.: 15/564,390

(22) PCT Filed: Apr. 11, 2016
(86) PCT No.: PCT/US2016/026958

§ 371 Date: Oct. 4, 2017

Related U.S. Application Data
(60) Provisional application No. 62/146,031, filed on Apr. 10, 2015.

(51) Int. Cl. H04L 12/801; H04W 28/02; H04W 92/02; H04W 28/08; H04W 84/12

(52) U.S. Cl. CPC H04L 47/29; H04W 28/0284; H04W 88/10; H04W 28/08; H04W 84/12; H04W 92/02

(57) ABSTRACT

A logical interface is used to facilitate the exchange of information (START) between a first radio network and a second network. The logical interface is realized by utilizing the user plane of the core network architecture to transmit information from the first radio network to the second radio network. Once the information is received by the second radio network, the second radio network determines at least one threshold value, which is sent to a user equipment device in communication with the second radio network. Upon receiving the at least one threshold value, the user equipment device can make traffic routing decisions, based on the at least one threshold value and other network-related parameters.

### CLAIM OF PRIORITY

The present application claims priority to Provisional Application No. 62/146,031 entitled “METHODS FOR EXCHANGING INFORMATION BETWEEN WLAN AND 3GPP RAN FOR TRAFFIC STEERING THRESHOLD DETERMINATION,” docket number TPRO 00269 US, filed Apr. 10, 2015, which is assigned to the assignee hereof and hereby expressly incorporated by reference in its entirety.

### REFERENCE TO CO-PENDING APPLICATIONS FOR PATENT

The present application relates to PCT Application, entitled “METHODS AND SYSTEMS FOR EXCHANGING INFORMATION OVER A CONTROL PLANE BETWEEN WLAN AND 3GPP RAN FOR TRAFFIC STEERING THRESHOLD DETERMINATION,” Reference Number TUTL 00269, filed on Apr. 11, 2016, and assigned to the assignee hereof and expressly incorporated by reference herein.

### FIELD

This invention generally relates to networks and more particularly to the exchange of information between two or more networks.

### BACKGROUND

Many wireless communication systems use base stations or access points to provide geographical service areas where wireless communication user equipment (UE) devices communicate with the base station or access point providing the particular geographical service area in which the wireless communication UE devices are located. The base stations and access points are connected within a network allowing communication links to be made between the wireless communication UE devices and other devices. In some circumstances, the wireless communication UE devices are capable of communicating on more than one type of network. In these situations, it may be advantageous to obtain network-related data to help inform a decision regarding which network a wireless communication UE device should use to transmit and receive data traffic.

### SUMMARY

A logical interface is used to facilitate the exchange of information between a first radio network and a second network. The logical interface is realized by utilizing the user plane of the core network architecture to transmit information from the first radio network to the second radio network. Once the information is received by the second radio network, the second radio network determines at least one threshold value, which is sent to a user equipment device in communication with the second radio network. Upon receiving the at least one threshold value, the user equipment device can make traffic routing decisions, based on the at least one threshold value and other network-related parameters.

### BRIEF DESCRIPTION OF THE DRAWINGS

FIG. 1 is a block diagram of an example of a system where a logical interface is used to exchange information between two radio networks.

FIG. 2 is a flowchart of an example of a method of utilizing the communication system of FIG. 1 to transmit a user plane signal containing a transparent information element and using the information in the information element to select a network to use for data transmission.

FIG. 3 is a flowchart of an example of a method of utilizing the communication system of FIG. 1 to transmit a user plane signal containing a non-transparent information element and to terminate the non-transparent information element to obtain the information in the information element.

FIG. 4 is a flowchart of an example of a method of utilizing the communication system of FIG. 1 to transmit a user plane signal containing a non-transparent information element, to terminate the non-transparent information element to obtain the information in the information element, and to determine new information from the information obtained by terminating the information element.

### DETAILED DESCRIPTION

Due to the increasing demands for wireless bandwidth, mobile network (cellular) operators are interested in offloading data traffic from their mobile networks to other networks that are capable of handling the data traffic from one or more of the wireless communication user equipment devices (UE devices) that are being served by the mobile network. A wireless local area network (WLAN) is one example of a network that can handle the data traffic from one or more of the UE devices, if certain conditions are met. The offloading of data traffic to the WLAN can help a mobile network from becoming too congested and affecting the level of service that the mobile network can provide to the UE devices being served by the mobile network.

Standards organizations such as 3^{rd} Generation Partnership Project (3GPP) are incorporating procedures in the communications standards to facilitate offloading/onloading traffic between a 3GPP Long-Term Evolution (LTE) Radio Access Network (RAN) and a WLAN. Although the systems and methods disclosed herein refer specifically to offloading/onloading traffic between the 3GPP RAN and a WLAN by providing the 3GPP RAN with information about the WLAN radio network, it is contemplated that the systems and methods could be modified such that the WLAN radio network is provided information about the 3GPP RAN. Likewise, the systems and methods disclosed herein could be modified to be used in conjunction with any suitable wireless communication networks other than a 3GPP RAN and a WLAN.

For routing UE data traffic between the 3GPP RAN and a WLAN, the 3GPP standard defines thresholds for parameters related to 3GPP RAN and WLAN. These thresholds assist UE devices in making traffic routing decisions (e.g., whether to route data traffic over the 3GPP RAN or over the WLAN). The base station (eNB) of the 3GPP RAN provides the thresholds to UE devices either by broadcast signaling or by unicast signaling. Both low and high thresholds are provided in order to assist the UE with network selection in both directions. In the systems and methods described herein, the UE devices make the traffic routing decisions. However, it is contemplated that the traffic routing decisions could be made by any other suitable system entities (e.g., base stations, access points, etc.) that have access to the required threshold information and to the parameters related to the 3GPP RAN and the WLAN.

The 3GPP RAN-related parameters used to make the traffic routing decisions are radio strength measurements, which include: the UE RSRPₘₑₐₛ (Reference Signal Received Power measurements) and the UE RSRQₘₑₐₛ (Reference Signal Received Quality measurements). The WLAN-related parameters used to make the traffic routing decisions include: a list of WLAN identifiers that may be considered for traffic offloading, UE measurement of the Beacon Received Signal Strength Indicator (BeaconRSSI), WLAN Channel Utilization (ChannelUtilizationWLAN), the WLAN backhaul downlink data rate (BackhaulRateDIWLAN), and the WLAN backhaul uplink data rate (BackhaulRateUIWLAN). Current values of each of the 3GPP RAN-related parameters and the WLAN-related parameters may be obtained by the UE by various methods: the UE measuring received signals for various characteristics, may be broadcast from the 3GPP RAN eNB and/or an access point/base station of the WLAN, or may be a response to a query by the UE.

The systems and methods described herein may be modified to utilize various combinations of the different network-related parameters, such combinations also possibly using a greater or lesser number of parameters than the specific example set forth above. For example, other WLAN-related parameters that may be useful in determining appropriate threshold levels may include: Basis Service Set (BSS) Load, UE Average Data Rate, BSS Average Access Delay, and BSS Access Controller Access Delay. Moreover, any other suitable network-related parameters not specifically listed here may be utilized to inform the traffic routing decision.

Once the UE has the thresholds and current values of the 3GPP RAN-related parameters and the WLAN-related parameters, the UE can compare the parameter values to the thresholds to make a traffic routing decision. In making the decision, the UE also utilizes a persistence time, TsteeringWLAN, which specifies a duration of time (e.g., a timer value) during which the conditions should be met before starting traffic steering between the 3GPP RAN and a WLAN. For example, when steering traffic from the 3GPP RAN to the WLAN, Conditions 1 and 2 must both be met for a time interval equal to or greater than the persistence time, TsteeringWLAN:

| Condition 1 (3GPP-related | |
|---|---|
| parameters) | Condition 2 (WLAN-related parameters) |
| RSRPₘₑₐₛ < RSRPₘₑₐₛ | ChannelUtilizationWLAN < |
| Minimum Threshold | ChannelUtilizationWLAN |
| | Maximum Threshold |
| RSRQₘₑₐₛ < RSRQₘₑₐₛ | BackhaulRateDIWLAN > |
| Minimum Threshold | BackhaulRateDIWLAN |
| | Minimum Threshold |
| | BackhaulRateUIWLAN > |
| | BackhaulRateUIWLAN |
| | Minimum Threshold |
| | BeaconRSSI > BeaconRSSI Minimum |
| | Threshold |

When steering traffic from a WLAN to the 3GPP RAN, Condition 3 or Condition 4 must be met for a time interval equal to or greater than the persistence time, TsteeringWLAN:

| Condition 3 (3GPP-related | |
|---|---|
| parameters) | Condition 4 (WLAN-related parameters) |
| RSRPₘₑₐₛ > RSRPₘₑₐₛ | ChannelUtilizationWLAN > |
| Minimum Threshold | ChannelUtilizationWLAN |
| | Maximum Threshold |
| RSRQₘₑₐₛ > RSRQₘₑₐₛ | BackhaulRateDIWLAN < |
| Minimum Threshold | BackhaulRateDIWLAN |
| | Minimum Threshold |
| | BackhaulRateUIWLAN < |
| | BackhaulRateUIWLAN |
| | Minimum Threshold |
| | BeaconRSSI < BeaconRSSI Minimum |
| | Threshold |

In the systems and methods described herein, the 3GPP RAN determines the thresholds that will be provided to the UE devices. However, the systems and methods may be modified so that other entities (e.g., other 3GPP entities, WLAN entities, or the UE devices) may determine the thresholds to be used when making traffic routing decisions. In systems in which the 3GPP RAN determines the thresholds and there is no direct protocol interface between the 3GPP RAN and the WLAN, the 3GPP RAN cannot obtain current information about the WLAN that can be used to determine the thresholds.

A network management system with access to both networks could be used to transfer information between the two networks. However, such a network management system would likely be inefficient and would not provide the 3GPP RAN with timely information. Another possible means of providing the 3GPP RAN with the WLAN-related parameters would be to specify an interface or reference point that provides a direct protocol connection between the two networks. However, such a direct interface would require a new signaling protocol to be defined that is terminated in the endpoints of the interface, where, in this case, the endpoints would be the two radio networks. Although a direct interface would achieve the desired result, it would be more advantageous to implement systems and methods for exchanging information between radio networks that does not require a new direct interface between the radio networks but uses the existing core network architecture protocols.

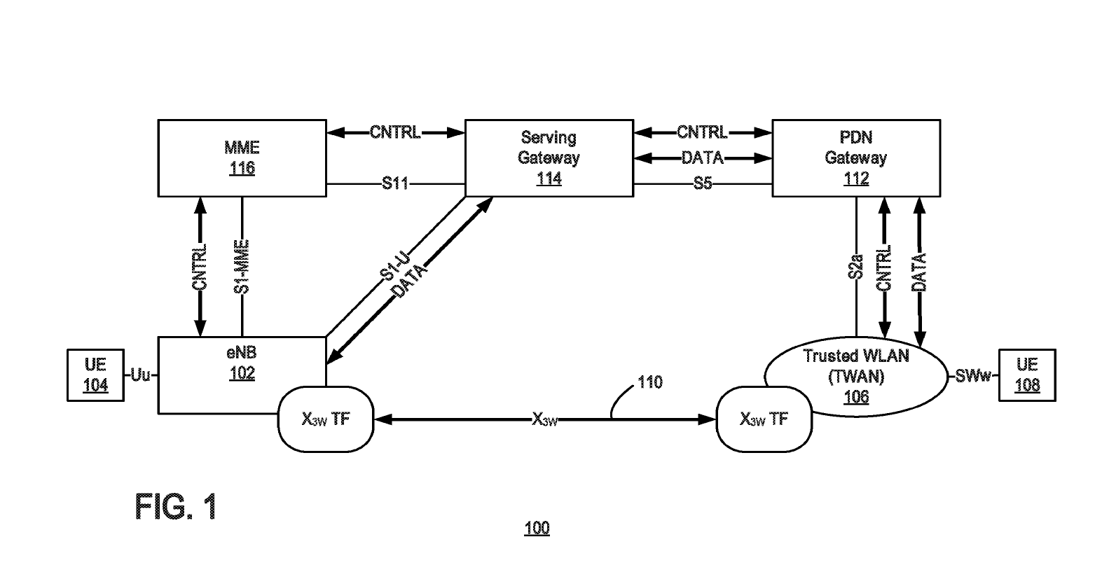

For present purposes, a logical interface is an interface that allows information to be exchanged between radio networks by encapsulating the information in the interface protocols of other network nodes that can provide the necessary connectivity rather than by using interface protocols that are dedicated for use between the radio networks. For present purposes, a reference point represents a relationship between two network functions, including the associated protocols. For example, the S5 reference point, discussed more fully below, identifies the relationship between a Packet Data Network (PDN) Gateway and a Serving Gateway, including the control plane and user plane protocols. FIG. 1 shows how a logical interface may be used to facilitate the exchange of information from a WLAN network to a 3GPP RAN so that the 3GPP RAN can determine the threshold values that should be sent to the UE devices so that the UE devices can make traffic routing decisions. In FIG. 1, the X_{3W} interface is shown between X_{3W} Termination Functions (TF) that are included in the eNB and the WLAN, respectively. However, according to an embodiment of the invention, the X_{3W} interface is realized by transporting the X_{3W} interface information using the protocols of the core network nodes, such as the PDN Gateway, Serving Gateway, and Mobility Management Entity (MME).

The various functions and operations of the blocks described with reference to the system 100 in FIG. 1 may be implemented in any number of devices, circuits, or elements. Two or more of the functional blocks may be integrated in a single device, and the functions described as performed in any single device may be implemented over several devices. A cellular communication system is typically required to adhere to a communication standard or specification.

The 3GPP LTE communication specification is a specification for systems where base stations (eNBs) provide service to UE devices using orthogonal frequency-division multiplexing (OFDM) on the downlink and single-carrier frequency-division multiple access (SC-FDMA) on the uplink. Although the techniques described herein may be applied in other types of communication systems, the exemplary systems discussed herein operate in accordance with a 3GPP LTE communication specification.

FIG. 1 includes a block diagram of an example of a system 100 where a logical interface is used to exchange information between two radio networks. More specifically, FIG. 1 shows a Network Reference Diagram that shows network functions and reference points for a 3GPP RAN interworking with a WLAN. For simplicity, only a selection of the network functions and reference points are shown in FIG. 1.

The system 100 includes a 3GPP base station (eNB) 102 that provides wireless service to UE device 104 via reference point Uu. The Radio Resource Control (RRC) signaling protocol is used over the Uu interface and is transported using the LTE air interface. The system 100 also includes a Trusted WLAN (TWAN) 106 that provides wireless service to UE device 108 via reference point SWw.

The base station 102 is a fixed transceiver station, sometimes referred to as an eNodeB or eNB, which may include a controller in some circumstances. The base station 102 includes a wireless transceiver (not shown) that exchanges wireless signals with UE device 104. Transmissions from the base station 102 and from the UE device 104 are governed by a communication specification that defines signaling, protocols, and parameters of the transmission. The communication specification may provide strict rules for communication and may also provide general requirements where specific implementations may vary while still adhering to the communication specification. Although the discussion below is directed to the 3GPP Long Term Evolution (LTE) communication specification, other communication specifications may be used in some circumstances. The communication specification defines at least a data channel and a control channel for uplink and downlink transmissions and specifies at least some timing and frequency parameters for physical downlink control channels from a base station to a wireless communication device.

The wireless UE devices 104, 108 may be referred to as mobile devices, wireless devices, wireless communication devices, mobile wireless devices, UEs, UE devices, as well as by other terms. The UE devices 104, 108 include electronics and code for communicating with base stations and with other wireless communication devices in D2D configurations. The wireless communication devices include devices such as cell phones, personal digital assistants (PDAs), wireless modem cards, wireless modems, televisions with wireless communication electronics, and laptop and desktop computers, as well as other devices. The combination of wireless communication electronics with an electronic device, therefore, may form a wireless communication device 104, 108. For example, a wireless communication device may include a wireless modem connected to an appliance, computer, television, or pool controller.

Although only one UE device is shown connected to the eNB 102 and the TWAN 106, more than one UE device may be attached to the eNB 102 and the TWAN 106. Also, one or more of the UE devices may be within or adjacent to the respective geographical service areas (not shown) of the eNB 102 and the TWAN 106. As the various UE devices move over time, various network-related parameters (e.g., signal strength, channel utilization, etc.) may change. By providing current information regarding the various network-related parameters from the TWAN 106 to the eNB 102, the eNB 102 can determine appropriate threshold values to send to the UE devices in communication with the eNB 102 so the UE devices can determine whether to route their data traffic over the 3GPP RAN or the WLAN.

In order to route the information (e.g., network-related parameters) from the TWAN 106 to the eNB 102, a logical interface, X_{3W}, 110 is used. The logical interface 110 is graphically shown in FIG. 1 as a direct connection between the eNB 102 (e.g., 3GPP RAN) and the TWAN 106, and termination functions, X_{3W} TF, are shown at the endpoints (e.g., eNB 102 and TWAN 106) of the logical interface 110. However, as stated above, the logical interface 110 is not a conventional direct connection. Rather, the graphical representation of the logical interface 110 is merely included to show the functionality of the logical interface 110, which is actually realized by utilizing the existing core network architecture reference points and protocols.

Although the termination function on the 3GPP RAN side of the logical interface 110 is shown as part of the eNB 102, the termination function on the 3GPP RAN side of the logical interface 110 could be located at any other suitable location within the 3GPP RAN that is capable of performing the termination function and then forwarding the WLAN-related parameter information to the eNB 102. The termination function on the WLAN side of the logical interface 110 is shown generically as part of the TWAN 106. However, the termination function on the WLAN side of the logical interface 110 could be located in any suitable location within the TWAN 106, including, for example, an access point (not shown) or an access controller (not shown) of the TWAN 106.

In the system of FIG. 1, the logical interface 110 is realized via the user plane between the 3GPP RAN and the WLAN. The user plane includes the core network reference points, connections, and protocols utilized to transmit and receive data packets between two radio networks (e.g., 3GPP RAN and WLAN). Communication over the user plane follows the path from the TWAN 106 to the eNB 102 indicated by the arrows marked “DATA.” The control plane includes the core network reference points, connections, and protocols utilized to transmit and receive core network control signals between two radio networks (e.g., 3GPP RAN and WLAN). As shown in FIG. 1, communication over the control plane follows the path from the TWAN 106 to the eNB 102 indicated by the arrows marked “CNTRL.” Since the systems and methods described herein focus on utilizing the user plane to realize the logical interface 110, the following discussion will be directed to describing how the information is sent to the 3GPP via the user plane.

For example, the information (e.g., WLAN-related parameters) to be sent to the 3GPP RAN is included in user plane signalling messages, which are transported in the protocol headers of data packets. The user plane signalling messages are initially transmitted from a transmission logical reference point (e.g., an access point or access controller, not shown separately) of the first radio network (e.g., TWAN 106). In the example shown in FIG. 1, the information is sent in a user plane signalling message from the TWAN 106 to at least one intermediate logical reference point before being received by a reception logical reference point (e.g., eNB 102) of the 3GPP RAN. More specifically, the TWAN 106 transmits the information as a user plane signal at the S2a reference point to the Packet Data Network (PDN) Gateway 112 (e.g., an intermediate logical reference point) of the 3GPP RAN. The S2a reference point is used to transfer user data and control data between the PDN Gateway 112 and the TWAN 106. The user data is transported using the General Packet Radio Service (GPRS) Tunneling Protocol for the user plane (GTP-U). The control data is transported using the GPRS Tunneling Protocol for the control plane (GTP-C).

In the system shown in FIG. 1, the information is transmitted as a transparent information element such that the user plane signal containing the transparent information element is transmitted to the reception logical reference point (e.g., eNB 102) without terminating the transparent information element at any of the intermediate logical reference points between the transmission logical reference point (e.g., TWAN 106) and the reception logical reference point. Since the transparent information element is not terminated by any of the intermediate logical reference points, each of the intermediate logical reference points simply forwards the user plane message containing the transparent information element without opening or otherwise inspecting the contents of the transparent information element.

Thus, the PDN Gateway 112 would simply forward the user plane message containing a transparent information element to the Serving Gateway 114 of the 3GPP RAN at the S5 reference point. The S5 reference point is used to transfer user data and control data between the Serving Gateway 114 and the PDN Gateway 112. The user data is transported using the GTP-U. The control data is transported using the GTP-C.

In turn, the Serving Gateway 114 forwards the user plane message containing the transparent information element to the eNB 102 (e.g., reception logical reference point) at the S1-U reference point. The S1-U reference point is used to transfer data between the eNB 102 and the Serving Gateway 114. The data is transported using the GTP-U.

The S11 reference point is used to transfer control data between the Serving Gateway 114 and the MME 116, using the GTP-C. The S1-MME reference point is used to transfer S1 Application Protocol (S1-AP) control data between the eNB 102 and the MME 116.

The system of FIG. 1 could be modified so that the information is transmitted as a non-transparent information element such that the user plane signal containing the non-transparent information element is terminated by at least one of the intermediate logical reference points (e.g., PDN Gateway 112 and Serving Gateway 114) between the transmission logical reference point (e.g., TWAN 106) and the reception logical reference point (e.g., eNB 102). In some instances, upon terminating the non-transparent information element, the information obtained by terminating the non-transparent information element can then be transmitted along the user plane toward the reception logical reference point (e.g., eNB 102).

In other instances, upon terminating the non-transparent information element, the intermediate logical reference point that terminated the non-transparent information element determines new information, based on the information obtained by terminating the non-transparent information element. The new information is then transmitted toward the reception logical reference point (e.g., eNB 102). For example, the information in the non-transparent information element could comprise a first set of one or more parameters associated with the first radio network (e.g., TWAN 106), and the new information could be obtained by translating the first set of one or more parameters into a second set of one or more parameters that are associated with a different network (e.g., 3GPP RAN) and that have a similar impact on threshold determination as the first set of one or more parameters.

Upon receiving the information, the eNB 102 determines, based on the information, one or more threshold values that are provided to the UE device 104. The UE device 104 selects, based on the at least one threshold value and the network-related parameters described above, one of the first radio network (e.g., TWAN 106) and the second radio network (e.g., 3GPP RAN) to use to transmit data traffic.

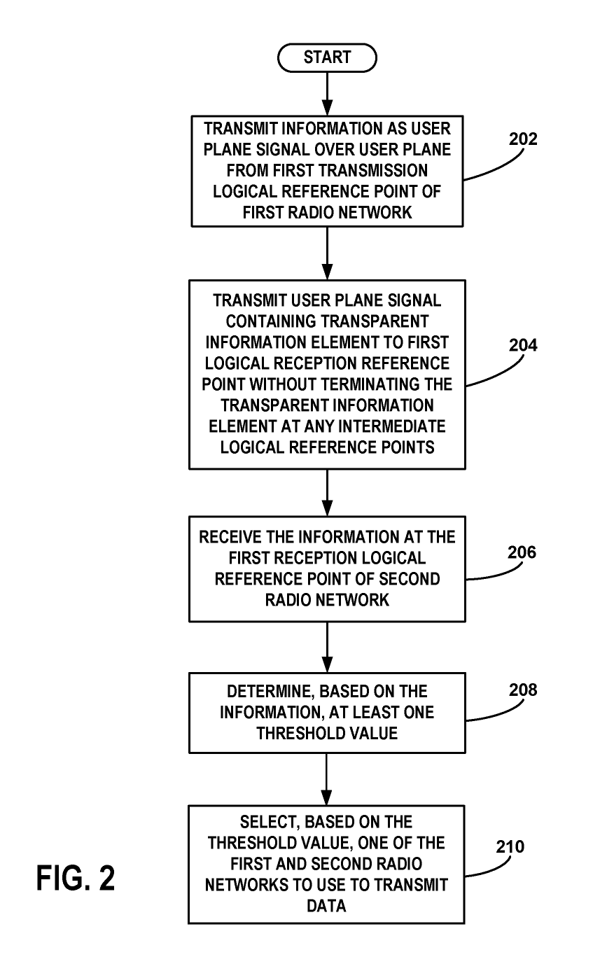

FIG. 2 is a flowchart of an example of a method of utilizing the communication system of FIG. 1 to transmit a user plane signal containing a transparent information element and using the information in the information element to select a network to use for data transmission.

At step 202, at reference point S2a, a first radio network (e.g., TWAN 106) transmits transparent information (e.g., WLAN-related parameters) as a user plane signal over the user plane. The WLAN-related parameters are sourced at the X_{3W} reference point, which is the initiating reference point (e.g., transmission logical reference point) and is internal to the first radio network. The S2a reference point may be realized in either an access point or an access controller of the TWAN 106. However, the reference point may be any other suitable portion of the TWAN 106 that is capable of transmitting the information as a user plane signal.

At step 204, a user plane signal containing the information as a transparent information element is transmitted to at least one intermediate core network node according to the associated reference point (e.g., PDN Gateway 112 and Serving Gateway 114) without terminating the transparent information element at any of the intermediate reference points between the initiating reference point (e.g., TWAN 106) and the terminating reference point (e.g., eNB 102). More specifically, although the user plane signal is transmitted to one or more intermediate core network nodes, none of the protocol functions associated with the intermediate reference points opens or otherwise inspects the contents of the transparent information element. Rather, each of the intermediate reference point protocols simply forwards the user plane message containing the transparent information element towards the terminating reference point (e.g., eNB 102).

At step 206, the transparent information is received at the intermediate reference point (e.g., S1-U) of the second radio network (e.g., 3GPP RAN) and is sent to the X_{3W} reference point, which is the terminating reference point that is internal to the eNB. The terminating reference point is also referred to herein as a “reception logical reference point.”

At step 208, at least one threshold value is determined, based on the information received at the terminating reference point. In the method shown in FIG. 2, the eNB 102 determines the threshold values. However, the method may be modified so that either another entity within the 3GPP RAN or the UE device 104 determines the threshold values.

At step 210, the UE device 104 selects, based on the at least one threshold value, one of the first radio network (e.g., TWAN 106) and the second radio network (e.g., 3GPP RAN) to use to route data traffic. The UE device 104 compares current network-related parameters (e.g., both those received over the user plane and those measured by the UE device 104) with the threshold values to make the determination of which radio network to use. Although the method of FIG. 2 shows the UE device 104 making the determination of which network to use, the method may be modified so that another entity within the 3GPP RAN (e.g., eNB 102) may make the determination on behalf of the UE device 104.

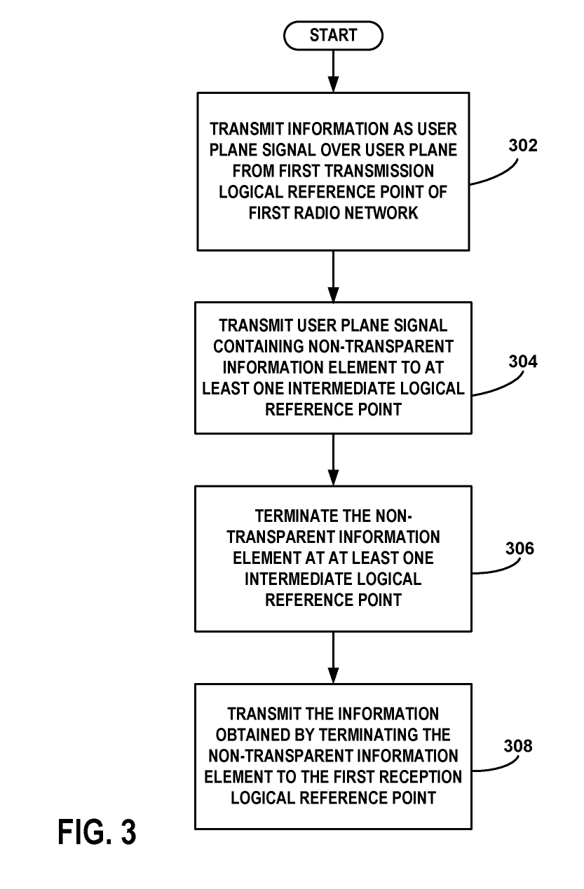

FIG. 3 is a flowchart of an example of a method of utilizing the communication system of FIG. 1 to transmit a user plane signal containing a non-transparent information element and to terminate the non-transparent information element to obtain the information in the information element.

At step 302, at reference point S2a, a first radio network (e.g., TWAN 106) transmits non-transparent information (e.g., WLAN-related parameters) as a user plane signal over the user plane. The WLAN-related parameters are sourced at the X_{3W} reference point, which is the initiating reference point that is internal to the first radio network. The S2a reference point may be realized in either an access point or an access controller of the TWAN 106. However, the reference point may be any other suitable portion of the TWAN 106 that is capable of transmitting the information as a user plane signal.

At step 304, the user plane signal containing the information as a non-transparent information element is transmitted to at least one intermediate core network node according to the associated reference point (e.g., PDN Gateway 112 and Serving Gateway 114) between the initiating reference point (e.g., TWAN 106) and the terminating reference point (e.g., eNB 102).

At step 306, at least one of the intermediate reference points that receives the user plane signal containing the non-transparent information element terminates the non-transparent information element. More specifically, at least one of the intermediate reference points opens or otherwise inspects the contents of the non-transparent information element.

At step 308, the information obtained by terminating the non-transparent information element is transmitted along the user plane toward the terminating reference point (e.g., eNB 102). As described above, at least one threshold value is determined, based on the information received at the terminating reference point, and the UE device 104 selects, based on the at least one threshold value and the current value of network-related parameters, one of the first radio network (e.g., TWAN 106) and the second radio network (e.g., 3GPP RAN) to use to transmit data traffic.

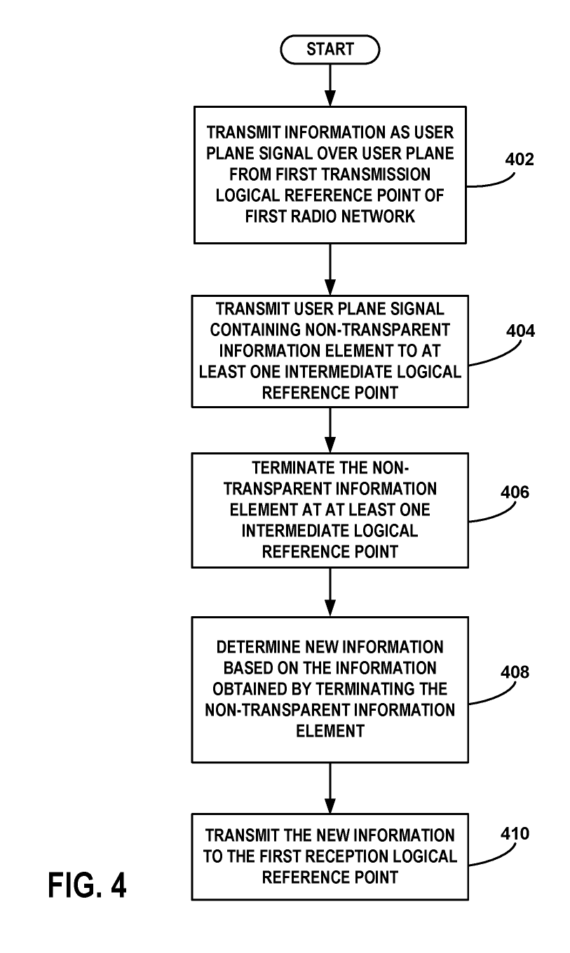

FIG. 4 is a flowchart of an example of a method of utilizing the communication system of FIG. 1 to transmit a user plane signal containing a non-transparent information element, to terminate the non-transparent information element to obtain the information in the information element, and to determine new information from the information obtained by terminating the information element.

At step 402, at reference point S2a, a first radio network (e.g., TWAN 106) transmits information (e.g., WLAN-related parameters) as a user plane signal over the user plane. The WLAN-related parameters are sourced at the X_{3W} reference point, which is the initiating reference point that is internal to the first radio network. The S2a reference point may be realized in either an access point or an access controller of the TWAN 106. However, the reference point may be any other suitable portion of the TWAN 106 that is capable of transmitting the information as a user plane signal.

At step 404, the user plane signal containing the information as a non-transparent information element is transmitted to at least one intermediate core network node according to the associated reference point (e.g., PDN Gateway 112 and Serving Gateway 114) between the initiating reference point (e.g., TWAN 106) and the terminating reference point (e.g., eNB 102).

At step 406, at least one of the intermediate reference points that receive the user plane signal containing the non-transparent information element terminates the non-transparent information element. More specifically, at least one of the intermediate reference points opens or otherwise inspects the contents of the non-transparent information element.

At step 408, at least one of the intermediate reference points that terminate the non-transparent information element determines new information, based on the information obtained by terminating the non-transparent information element. For example, the information in the non-transparent information element could comprise a first set of one or more parameter values associated with the first radio network (e.g., TWAN 106), and the new information could be obtained by translating the first set of one or more parameter values into a second set of one or more parameter values that are associated with a different network (e.g., 3GPP RAN) and that have a similar impact on threshold determination as the first set of one or more parameter values.

At step 410, the new information is transmitted toward the terminating reference point (e.g., eNB 102). Upon receiving the new information, the terminating reference point determines at least one threshold value, and the UE device 104 selects, based on the at least one threshold value and the current values of network-related parameters, one of the first radio network (e.g., TWAN 106) and the second radio network (e.g., 3GPP RAN) to use to transmit data traffic.

Although various combinations of steps have been described in connection with each of the methods shown in FIGS. 2-4, any of the steps disclosed herein may be added to or deleted from any particular combination of steps shown in the methods of FIGS. 2-4.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A method comprising:
exchanging information between a first radio network and a second radio network, the first radio network connected to the second radio network through a communication link having a communication architecture comprising
a user plane for exchanging data signals between the first radio network and the second radio network, and
a control plane for exchanging control signals between the first radio network and the second radio network, the exchanging the information comprising:
transmitting the information as a user plane signal over the user plane from a first transmission logical reference point of the first radio network; and
receiving the information at a first reception logical reference point of the second radio network, where the first transmission logical reference point and the first reception logical reference point serve as endpoints of a logical interface between the first radio network and the second radio network that utilizes the user plane of the communication architecture to exchange information between the first radio network and the second radio network.

2. The method of claim 1, further comprising:
transmitting the user plane signal to at least one intermediate logical reference point between the first transmission logical reference point and the first reception logical reference point.

3. The method of claim 2, wherein the information is transmitted as a transparent information element such that the user plane signal containing the transparent information element is transmitted to the first reception logical reference point without terminating the transparent information element at any intermediate logical reference points between the first transmission logical reference point and the first reception logical reference point.

4. The method of claim 2, wherein the information is transmitted as a non-transparent information element such that the non-transparent information element is terminated by at least one intermediate logical reference point between the first transmission logical reference point and the first reception logical reference point.

5. The method of claim 4, further comprising:
transmitting, to the first reception logical reference point, the information obtained by terminating the non-transparent information element.

6. The method of claim 4, further comprising:
determining new information, based on the information obtained by terminating the non-transparent information element; and
transmitting the new information to the first reception logical reference point.

7. The method of claim 6, wherein the information comprises a first set of one or more parameters associated with the first radio network, and wherein determining the new information comprises translating the first set of one or more parameters into a second set of one or more parameters that are associated with a different network and that have a similar impact on threshold determination as the first set of one or more parameters.

8. The method of claim 1, further comprising:
determining, based on the information, at least one threshold value.

9. The method of claim 8, further comprising:
selecting, based on the at least one threshold value, one of the first radio network and the second radio network for a user equipment device to use to transmit data traffic.

10. A system, comprising:
a first radio network having a first transmission logical reference point;
a second radio network having a first reception logical reference point; and
a communication link communicatively coupling the first radio network and the second radio network, the communication link having a communication architecture comprising
a user plane for exchanging data signals between the first radio network and the second radio network, and
a control plane for exchanging control signals between the first radio network and the second radio network,
the first transmission logical reference point configured to transmit information as a user plane signal over the user plane and the first reception logical reference point configured to receive the information transmitted by the first transmission logical reference point, where the first transmission logical reference point and the first reception logical reference point serve as endpoints of a logical interface between the first radio network and the second radio network that utilizes the user plane of the communication architecture to exchange information between the first radio network and the second radio network.

11. The system of claim 10, wherein the logical interface further comprises at least one intermediate logical reference point between the first transmission logical reference point and the first reception logical reference point.

12. The system of claim 11, wherein the first transmission logical reference point is further configured to transmit the information as a transparent information element such that the user plane signal containing the transparent information element is transmitted to the first reception logical reference point without terminating the transparent information element at any intermediate logical reference points between the first transmission logical reference point and the first reception logical reference point.

13. The system of claim 11, wherein the first transmission logical reference point is further configured to transmit the information as a non-transparent information element such that the non-transparent information element is terminated by at least one intermediate logical reference point between the first transmission logical reference point and the first reception logical reference point.

14. The system of claim 13, wherein the at least one intermediate logical reference point is configured to transmit, to the first reception logical reference point, the information obtained by terminating the non-transparent information element.

15. The system of claim 13, wherein the at least one intermediate logical reference point is configured to:
determine new information, based on the information obtained by terminating the non-transparent information element; and
transmit the new information to the first reception logical reference point.

16. The system of claim 15, wherein the information comprises a first set of one or more parameters associated with the first radio network and the new information comprises a second set of one or more parameters that are associated with a different network and that have a similar impact on threshold determination as the first set of one or more parameters.

17. The system of claim 10, further comprising:
a user equipment device configured to receive threshold information from the first reception logical reference point, where the threshold information is based on the information received from the first transmission logical reference point.

18. The system of claim 17, wherein the user equipment device is further configured to determine, based on the threshold information, whether to transmit traffic over the first radio network or the second radio network.
